(19) United States
(12) Patent Application Publication
(10) Pub. No.: US 2025/0168631 A1
(43) Pub. Date: May 22, 2025

(54) METHOD FOR AUTHENTICATING A CENTRAL UNIT CONNECTED TO PERIPHERAL UNITS USING A SECURE SERVER

(71) Applicant: Continental Automotive Technologies GmbH, Hannover (DE)

(72) Inventors: Jean-Philippe BOISSET, Montauban (FR); Stefan ABELING, Ulm (DE)

(73) Assignee: Continental Automotive Technologies GmbH, Hannover (DE)

(21) Appl. No.: 18/839,145

(22) PCT Filed: Apr. 21, 2023
(86) PCT No.: PCT/EP2023/060510

§ 371 Date: Aug. 16, 2024

(30) Foreign Application Priority Data
Apr. 27, 2022 (FR) FR2203921

(51) Int. Cl. H04W 12/0431; H04W 4/40; H04W 12/033

(52) U.S. Cl. CPC H04W 12/0431; H04W 4/40; H04W 12/033

(57) ABSTRACT

A method for authenticating the rights of a central unit communicating with peripheral units carrying out measurements on the tires of the wheels of a motor vehicle to carry out sensitive operations thereon, using a secure external server that possesses their identifier. Each peripheral unit generating a random session code transmitted to the server with its identifier, the identifier of the peripheral unit and the session code, the server performs an encryption with a dynamic encryption key shared with the peripheral unit to form a dynamic first encryption key, then performs a second encryption with the identifier of the central unit to give encrypted central-unit information transmitted to the peripheral unit, which performs the same encryption to form a temporary second encryption key, then an inverse decryption giving a decrypted identifier, then compares this decrypted identifier with the identifier of the central unit with a view to granting its authentication.

This application is the U.S. National Phase Application of PCT International Application No. PCT/EP2023/060510, filed Apr. 21, 2023, which claims priority to French Patent Application No. 2203921, filed Apr. 27, 2022, the contents of such applications being incorporated by reference herein.

### FIELD OF THE INVENTION

The present invention relates to a method for authenticating the rights of a central unit to communicate with peripheral wheel units using a secure server connected by an Internet link, in order to carry out sensitive operations on these peripheral units, and to units and a motor vehicle comprising devices implementing this method.

### BACKGROUND OF THE INVENTION

One type of method for communicating between a tire-pressure monitoring system (TPMS) of a motor vehicle and a smart device of a user of this vehicle, which is in particular described in the document FR-A1-3084310, incorporated by reference herein, comprises one peripheral unit installed on each wheel of the vehicle, which unit measures parameters, such as the inflation pressure and the temperature of the tire, that are transmitted by radio, and particularly using the Bluetooth standard, to a central unit located in the vehicle, which receives the information in order to process it and inform/alert the driver or a repairer should a problem be detected.

In particular, the wheel units periodically transmit information to the central unit, using a specific unique identifier allowing the wheel in question to be identified. Each wheel unit also possesses a radio receiver that receives signals from the central unit, in order to perform diagnostic, configuration or learning operations on this wheel unit.

The method employs UHF waves (UHF standing for Ultra-High Frequency) the frequency of which exceeds one gigahertz, allowing new applications such as exchange with devices exterior to the vehicle, in particular a smart phone of the user.

Moreover, generally, in the case of a system carrying out radio exchanges between a central unit of a user or client and peripheral units recording data, for example for these tire-pressure monitoring systems, it may be necessary to perform sensitive operations on these peripheral units, such as reprogramming them, using the Internet and cloud-computing services.

Each unit possesses as identifier a specific MAC address stored in a physical memory (MAC standing for Medium Access Control). Authentication of the central unit of the user by the peripheral units with a view to carrying out sensitive operations such as reprogramming thereon is problematic, as it is difficult, simply, without burdening the server with exchanges of large volumes of data, to ensure a high level of security in order to avoid undesirable interventions by third parties such as cracking, and the confidentiality of the data exchanges.

The aim of the present invention is in particular to avoid these problems of the prior art.

### SUMMARY OF THE INVENTION

To this end it proposes a method for authenticating the rights of a central unit of a user communicating bidirectionally by radio with one or more peripheral units carrying out measurements on the tires of the wheels of a motor vehicle, which measurements are transmitted to this central unit, to carry out sensitive operations thereon, each central unit and peripheral unit possessing a specific identifier, this method using via the Internet a secure external server that possesses in a database the identifier of the peripheral wheel units, and a symmetric encryption key that is shared with each peripheral wheel unit, this method being noteworthy in that it comprises the following successive steps:
in a first step, the central unit uses its identifier and a password to have itself recognized by each peripheral wheel unit, while in parallel the central unit sets up a secure link with the server by authenticating itself so that the server may recognize in its database the identifier of the peripheral wheel unit in question;
in a second step, the peripheral wheel unit generates a new random session code and notifies the central unit thereof;
in a third step, the central unit transmits to the server its identifier, the identifier of the peripheral wheel unit and the session code to ask it for proof of its authentication in order to obtain administrative rights over this peripheral wheel unit;
the server performs, in a fourth step, a first encryption with the shared encryption key recognized by its identifier, and with the session code to form a random and shared dynamic temporary first encryption key, then performs, in a fifth step, a second encryption with the identifier of the central unit and this dynamic temporary first encryption key to give encrypted central-unit information by way of proof of authentication;
in a sixth step, the encrypted central-unit information is transmitted to the central unit, then, in a seventh step, the central unit transmits it in turn to the peripheral wheel unit;
the peripheral wheel unit performs in parallel, in an eighth step, the same first encryption as the one performed by the server in its fourth step, with its shared encryption key and its session code, to form a temporary second encryption key, then it performs, in a ninth step, an inverse decryption of the second encryption of the fifth step, with the temporary second encryption key and the encrypted information giving a decrypted identifier; and lastly
in a tenth step, the peripheral wheel unit compares the decrypted identifier with the identifier of the central unit so as, if they coincide, to grant this central unit its authentication.

One advantage of the authenticating method according to an aspect of the invention is that it allows the procedure of encryption of the source files stored in the server to be simplified, in order to avoid overloading this server, the encrypted files being created only once for all the peripheral wheel units.

The method for authenticating rights according to an aspect of the invention may further comprise one or more of the following features, which may be combined with one another.

Advantageously, in a following step, the secure server generating and hosting a dynamic special encryption key uses it to encrypt a software source file giving an encrypted file, then, in a following step, the server uses the dynamic shared first encryption key to encrypt the special encryption key thereby giving a new encrypted key, then, in a following step, the server delivers to the central unit the encrypted file and the new encrypted key, this central unit delivering them in turn in a following step to the peripheral wheel unit.

In this case, advantageously, in a following step, the peripheral wheel unit uses the new encrypted key and the dynamic temporary first encryption key to form the same special encryption key as the one held by the server, then, in a following step, the peripheral wheel unit uses the special encryption key to decrypt the encrypted file with an inverse operation to the encryption operation carried out previously by the server, in order to deliver the source file.

Advantageously, the source file is then verified with a checksum before being programmed into the memory of the peripheral wheel unit.

Advantageously, the secure link with the server uses an HTTPS protocol, HTTPS standing for HyperText Transfer Protocol Secure.

Advantageously, once the secure link with the server has been set up, the server verifies in its database whether the central unit is authorized to communicate with the peripheral wheel units.

Advantageously, during a given communication session opened with the peripheral wheel unit, the central unit again sends it the encrypted information by way of proof of authentication without using the server.

Another aspect of the invention is a system comprising a central unit, and peripheral wheel units carrying out measurements, which are connected to one another by radio, comprising devices implementing a method comprising any one of the preceding features.

An aspect of the invention also relates to a motor vehicle comprising a central unit, and peripheral wheel units carrying out measurements on the tires of the wheels of this vehicle, comprising devices implementing a method comprising any one of the preceding features.

### BRIEF DESCRIPTION OF THE DRAWINGS

FIG. 1 is a functional schematic showing the method according to an aspect of the invention for authenticating a central unit located in a motor vehicle, which unit is connected to peripheral wheel units that are fastened to the wheels of the vehicle; and

FIG. 2 is a functional schematic showing, after this authentication, reprogramming of peripheral wheel units.

### DETAILED DESCRIPTION OF EXEMPLARY EMBODIMENTS

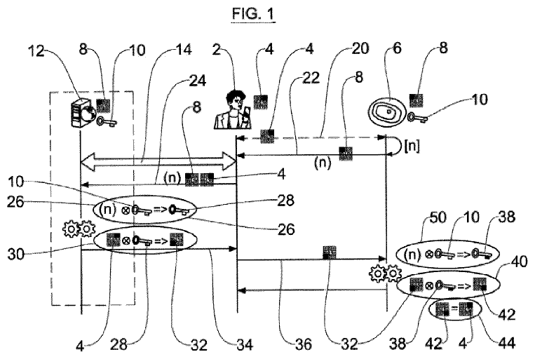

FIG. 1 shows, in a motor vehicle, a central unit 2 that forms a client having available to it a central-unit identifier 4 and, on each wheel, one peripheral wheel unit 6 that comprises sensors of the pressure and temperature of the tire of the wheel, and that has available to it a peripheral wheel unit identifier 8 and a symmetric shared specific encryption key 10, recorded during manufacture of this unit. The central unit 2 and the peripheral wheel units 6 communicate with each other in particular using the using Bluetooth® standard.

An Internet network 14 using a radio link allows the central unit 2 to be connected to a secure external server 12 containing a database comprising, for each peripheral wheel unit 6, its identifier 8 and its shared encryption key 10.

The method for authenticating the central unit 2, to allow sensitive operations to be carried out on the peripheral wheel units 6, comprises a first step 20 of using the identifier of the central unit 4 and a password to have the central unit recognized by the one specific peripheral wheel unit 6, and the connection accepted.

In parallel, the central unit 2 is connected by a secure link 14 to the server 12, so that the server may recognize in its database the identifier of the specific unit 6 in question. Advantageously, a secure HTTPS link is used (HTTPS standing for HyperText Transfer Protocol Secure), for example one set up with the identifier of the central unit 4 and a password.

In a second step 22, the peripheral wheel unit 6 generates a new session code, which may in particular be a random session number (n), and notifies the central unit 2 thereof.

In a third step 24, the central unit 2 transmits to the server 12 its identifier 4, the identifier 8 of the peripheral wheel unit 6 and the session number (n) to ask it for proof of its authentication in order to obtain administrative rights over this peripheral wheel unit. The server 12 then verifies in its database whether the central unit 2 is authorized to communicate with this peripheral wheel unit 6, using their respective identifiers 4, 8.

If the central unit 2 is authorized to communicate with the peripheral wheel unit 6, in a fourth step 26 the server 12 performs a first encryption with the shared encryption key 10, which is recognized by its identifier 8, and with the session number (n) to form a random and shared dynamic temporary first encryption key 28.

The server 12 then performs, in a fifth step 30, a second encryption with the identifier of the central unit 4 and this dynamic temporary first encryption key 28 in order to produce encrypted central-server information 32 forming a proof of authentication.

In a sixth step 34, the server 12 transmits to the central unit 2 the encrypted proof-of-authentication information 32. In a seventh step 36, the central unit 2 in turn transmits to the particular unit 6 the encrypted proof-of-authentication information 32.

In parallel with the operations performed by the secure server 12, in an eighth step 50 the peripheral wheel unit 6 performs the same fourth step of first encryption 26 carried out by the server 12, by using its shared encryption key 10 and its session number (n) to form a temporary second encryption key 38. The peripheral wheel unit 6 then performs, in a ninth step 40, an inverse decryption of the fifth step 30 of the second encryption, with the temporary second encryption key 38 and the encrypted proof-of-authentication information 32, giving a decrypted identifier 42.

In a final tenth step 44, the peripheral wheel unit 6 compares the decrypted identifier 42 with the identifier of the central unit 4, and, if they coincide, it then grants this central unit its authentication. In this way, a validation is obtained by the remote secure server 12 of the authentication of the central unit 2, which is then authorized to perform on the peripheral wheel unit 6 sensitive operations such as its reprogramming with a high level of security and confidentiality.

With this method, the central unit 2 may subsequently again give this proof to the peripheral wheel unit 6, without recourse to the server 12, but only during the same communication session with this peripheral wheel unit. In this way an external person wanting to crack the system by seeking to connect during the following session will not be capable of giving this proof again and will not be able to pass themselves off as the client.

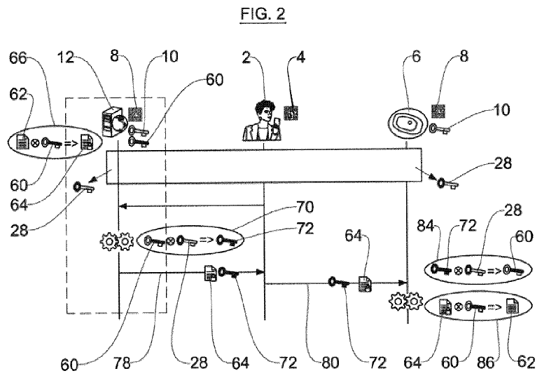

FIG. 2 shows the secure server 12 generating and hosting a dynamic special encryption key 60 that is used, in an encryption operation 66, to encrypt a software source file 62 thereby giving an encrypted file 64 that is to be loaded into the peripheral wheel unit 6. In all cases, the server 12 keeps an identical image of the file present in the peripheral wheel unit 6. In particular, the dynamic special encryption key 60 may be unique and used to encrypt a single source file 62, or may be used to encrypt every file.

After the preceding sequence of authentication of the central unit 2, the central unit 2 having obtained the status of administrator, the dynamic temporary first encryption key 28 is shared between the server 12 and the peripheral wheel unit 6.

In a following step 70, the server 12 uses the shared dynamic temporary first encryption key 28 to encrypt the special encryption key 60, thereby giving a new encrypted key 72 that may be shared with the peripheral wheel unit 6.

In a following step 78, the server 12 delivers to the central unit 2 the encrypted file 64 and the new encrypted key 72, this central unit delivering them in turn, in a following step 80, to the peripheral wheel unit 6.

In a following step 84, the peripheral wheel unit 6 uses the new encrypted key 72 and the new shared dynamic encryption key 28 to form the same special encryption key 60 as the one held by the server 12. Lastly, in a following step 86, the peripheral wheel unit 6 uses the special encryption key 60 to decrypt the encrypted file 64 with an inverse operation to the encryption operation 66 carried out previously by the server 12, in order to deliver the source file 62. The source file 62 is then verified with a checksum, then it is programmed into the memory of the peripheral wheel unit 6 with a view to being used.

The principle of the method according to an aspect of the invention is to always use the same special encryption key 60 to encode the files 62, this avoiding the systematic encoding phase. Since the special encryption key 60 is unknown to the peripheral wheel units 6, the new encrypted key 72 is transmitted encrypted by virtue of the shared dynamic encryption key 28 advantageously created during the authenticating phase.

Decryption of the encrypted key 72 is not possible on the central unit 2, since a cracker does not possess the shared dynamic temporary encryption key 28 created after authentication. This method remains secure provided that the special encryption key 60 is not known to crackers.

Advantageously, the encryptions and decryptions are performed according to AES-128 (AES standing for Advanced Encryption Standard).

The authenticating method according to an aspect of the invention is particularly suitable for monitoring tires of a motor vehicle, in order to signal faults to the user or to a repairer or to prevent them. It also allows motor-vehicle manufacturers or tire manufacturers to receive information on an external server with a view to track its products and improve quality.

1. A method for authenticating the rights of a central unit of a user communicating bidirectionally by radio with one or more peripheral wheel units carrying out measurements on the tires of the wheels of a motor vehicle, which measurements are transmitted to this central unit, to carry out sensitive operations thereon, each central unit and peripheral wheel unit possessing a specific identifier, this method using via the Internet a secure external server that possesses in a database the identifier of the peripheral wheel units, and a symmetric encryption key that is shared with each peripheral wheel unit, the method comprising:
in a first step, the central unit uses its identifier and a password to have itself recognized by each peripheral wheel unit, while in parallel the central unit sets up a secure link with the server by authenticating itself so that the server may recognize in its database the identifier of the peripheral wheel unit in question;
in a second step, the peripheral wheel unit generates a new random session code and notifies the central unit thereof;
in a third step, the central unit transmits to the server its identifier, the identifier of the peripheral wheel unit and the session code to ask it for proof of its authentication in order to obtain administrative rights over this peripheral wheel unit;
the server performs, in a fourth step, a first encryption with the shared encryption key recognized by its identifier, and with the session code to form a random and shared dynamic temporary first encryption key, then performs, in a fifth step, a second encryption with the identifier of the central unit and this dynamic temporary first encryption key to give encrypted central-unit information by way of proof of authentication;
in a sixth step, the encrypted information is transmitted to the central unit, then, in a seventh step, the central unit transmits it in turn to the peripheral wheel unit;
the peripheral wheel unit performs in parallel, in an eighth step, the same first encryption as the one performed by the server in its fourth step, with its shared encryption key and its session code, to form a temporary second encryption key, then it performs, in a ninth step, an inverse decryption of the second encryption of the fifth step, with the temporary second encryption key and the encrypted information giving a decrypted identifier; and lastly
in a tenth step, the peripheral wheel unit compares the decrypted identifier with the identifier of the central unit so as, if they coincide, to grant this central unit its authentication.

2. The method as claimed in claim 1, further comprising, the secure server generating and hosting a dynamic special encryption key uses it to encrypt a software source file giving an encrypted file, then, in a following step, the server uses the dynamic temporary first encryption key to encrypt the special encryption key thereby giving a new encrypted key, then, in a following step, the server delivers to the central unit the encrypted file and the new encrypted key, this central unit delivering them in turn in a following step to the peripheral wheel unit.

3. The method as claimed in claim 2, further comprising, the peripheral wheel unit uses the new encrypted key and the new shared dynamic encryption key to form the same special encryption key as the one held by the server, then, in a following step, the peripheral wheel unit uses the special encryption key to decrypt the encrypted file with an inverse operation to the encryption operation carried out previously by the server, in order to deliver the source file.

4. The method as claimed in claim 3, the source file is then verified with a checksum before being programmed into the memory of the peripheral wheel unit.

5. The method as claimed in claim 1, wherein the secure link with the server uses an HTTPS protocol, HTTPS standing for HyperText Transfer Protocol Secure.

6. The method as claimed in claim 1, wherein once the secure link with the server has been set up, the server verifies in its database whether the central unit is authorized to communicate with the peripheral wheel units.

7. The method as claimed in claim 1, wherein, during a given communication session opened with the peripheral wheel unit, the central unit again sends it the encrypted information by way of proof of authentication without using the server.

8. A system comprising a central unit, and peripheral wheel units carrying out measurements on the tires of the wheels of a motor vehicle, which are connected to one another by radio, characterized in that it comprises devices implementing a method as claimed in claim 1.

9. A motor vehicle comprising a central unit, and peripheral wheel units carrying out measurements on the tires of the wheels of this vehicle, comprising devices implementing a method as claimed in claim 1.
